(19) United States
(12) Patent Application Publication
(10) Pub. No.: US 2011/0290081 A1
(43) Pub. Date: Dec. 1, 2011

(54) RATCHET PULLEY SYSTEMS

(76) Inventor: Andre Bradford, Landcaster, CA (US)

(21) Appl. No.: 13/108,718

(22) Filed: May 16, 2011

Related U.S. Application Data
(60) Provisional application No. 61/350,062, filed on Jun. 1, 2010.

(51) Int. Cl. B25B 13/46

(52) U.S. Cl. 81/57.46

(57) ABSTRACT

The general purpose of the ratchet pulley system is to provide the user with a tool capable of greater speed, convenience, and torque in loosening or tightening fasteners. The torque multiplying ratchet pulley preferably comprises an extruded drive lug; a grippable housing disk; at least one pulley (rotatable/non-rotatable); a pawl; and a recoilable pull-cable (or non-recoilable version in certain embodiments) with a handle (T-shaped) wherein the extruded drive lug is preferably connected to a recoilable pull-cable such that when a user pulls the recoilable pull-cable via the handle, the extruded drive lug is rotated allowing a fastener to be turned (tightened or loosened.)

### CROSS-REFERENCE TO RELATED APPLICATION

The present application is related to and claims priority from prior provisional application Ser. No. 61/350,062, filed Jun. 1, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of hand tools and more specifically relates to a ratcheting pulley system.

2. Description of the Related Art

In modern society, mechanical hand tools are used for nearly anything that is assembled with a fastener. These tools are used extensively in the automotive, building, aeronautical, industrial, and utility business, to name a few. The most common fastening means used is a hex nut or hex head bolt. Wrenches have been made in graduated sizes to fit every size of hex nut or hex head bolt. Due to the need for higher efficiency and reduced time spent on repairs, ratcheting wrenches or socket drivers have been developed that employ the use of a hex socket. The socket wrench typically is of the ratchet type. The ratcheting mechanism allows the nut to be tightened or loosened with a reciprocating motion, without requiring that the wrench be removed and refitted after each turn. Typically, a small lever on the ratchet head switches the wrench between tightening and loosening mode. The sockets are attached to the ratchet through a square fitting that contains a spring loaded ball detent mechanism to keep the sockets in place.

A socket wrench is typically a wrench with a female socket (recess) that grips the male head of a fastener or fitting in order to apply torque to it (either to rotate it or to keep it from rotating). The principal application of socket wrenches is to loosen or tighten fasteners such as nuts and bolts. The most widespread form of socket wrench today is a hand tool version comprising a socket set with dozens of indexable sockets and a ratchet wrench with a rigid handle containing a built in ratcheting mechanism. The advantage of the system of a ratchet wrench with indexable sockets is speed of wrenching. The socket wrench typically is of the ratchet type. The ratcheting mechanism allows the nut to be tightened or loosened with a reciprocating motion, without requiring that the wrench be removed and refitted after each turn. It is much faster than a conventional wrench, especially in repetitive bolt-on or bolt-off usage. The handle provides the mechanical advantage to supply the torque by hand. The amount of torque that can be supplied is proportional to the length of the handle (lever arm) on the socket wrench. Modern nuts and bolt heads are made with hexagonal gripping surfaces and as such limit the number of positions a wrench can adopt when placed over them. Sockets may be produced in 6-point (hexagonal) and 12-point (double-hexagonal) configurations. Sockets with a 12-point configuration also allow a greater range of motion than 6-point sockets because of the circular reciprocating motion required for tightening or loosening fasteners. Often, the use of these tools are in confined spaces such as in engine compartments, and the choice of a 12-point or a 6-point socket is often determined by the amount of space available to rotate the wrench handle. The usefulness and speed of a ratcheting socket wrench becomes more restricted as the space to use it in becomes smaller.

Various attempts have been made to solve the above-mentioned problems such as those found in U.S. Pat. Nos. 1,306,553 to Mobbisoet et al.; 4,224,844 to Henricksen; and 6,167,785 to Penner. This prior art is representative of ratcheting socket wrenches. None of the above inventions and patents, taken either singly or in combination, is seen to describe the invention as claimed.

Ideally, a ratcheting pulley system should be easy to use and time-efficient in-use, yet operate reliably and be manufactured at a modest expense. Thus, a need exists for a reliable ratchet pulley system to remove and install fasteners and to avoid the above-mentioned problems.

### BRIEF SUMMARY OF THE INVENTION

In view of the foregoing disadvantages inherent in the known socket wrench art, the present invention provides a novel ratchet pulley system. The general purpose of the present invention, which will be described subsequently in greater detail is to provide the user with a tool capable of greater speed, convenience, and torque in loosening or tightening fasteners.

Disclosed is a torque multiplying ratchet pulley preferably comprising an extruded drive lug; a grippable housing disk; at least one pulley (rotatable/non-rotatable); a pawl; and a recoilable pull-cable (or non-recoilable version in certain embodiments) with a handle (T-shaped) wherein the extruded drive lug is preferably connected to a recoilable pull-cable such that when a user pulls the recoilable pull-cable via the handle, the extruded drive lug is rotated. The pulley is rotatable with the extruded drive lug and is enclosed within a grippable housing disk wherein the recoilable pull-cable is wound circumferentially around the pulley and wherein the pulley has ratchet teeth circumferentially located into which the pawl engages to create an incremental stop and go movement and comprises a position lock.

The recoilable pull-cable may be pulled tangentially from the pulley via the T-bar handle which is used to create at least one torque moment. The torque multiplying ratchet pulley pawl comprises an engaging/disengaging lever in preferred embodiments. The extruded drive lug is rotationally reversible when the engaging/disengaging lever has disengaged the pawl. The extruded drive lug comprises a through shaft within the grippable housing disk and extends centrally through it and is affixed (rotationally via bearings or non-rotationally) to the pulley such that it is rotatable in relation to the grippable housing disk. A braided steel recoilable pull-cable is affixed to the shaft, wound around the pulley, and terminates in a T-shaped handle. The grippable housing disk is preferably circumferentially bonded with a rubber grip to create a friction-gripping surface. The torque multiplying ratchet pulley recoilable pull-cable may be manipulatable via a rigid arm which is removably couplable (via suitable means) in certain embodiments. The torque multiplying ratchet pulley rigid arm locks to grippable housing disk allowing a user to apply a torque moment when the pawl position lock is in the locked condition thereby creating a direct drive. The extruded drive lug comprises a ½″ drive or a ⅜″ drive cubed profile and is insertable into a socket.

A kit for manufacture and resale is disclosed herein including: a torque multiplying ratchet pulley; at least one removable rigid handle; optionally a set of sockets; and a set of user instructions.

A method of use for a torque multiplying ratchet pulley is also described comprising the steps of: attaching a standard SAE or a Metric socket onto the extruded drive lug; selecting a direction of rotation with the rotation selector; connecting the socket to a fastener; pulling the recoilable pull-cable via the handle to loosen or tighten the fastener; and removing the socket when the fastener is adequately tightened or loosened. The method further comprises the step of locking or unlocking the pawl position lock to retain a suitable fastener positioning.

The present invention holds significant improvements and serves as a ratchet pulley system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ratchet pulley system, constructed and operative according to the teachings of the present invention.

FIG. 1 shows a perspective view illustrating a ratchet pulley system in an in-use condition according to an embodiment of the present invention.

FIG. 2 is a bottom perspective view of the ratchet pulley system according to an embodiment of the present invention of FIG. 1.

FIG. 3 is a top perspective of the ratchet pulley system according to an embodiment of the present invention of FIG. 1.

FIG. 4 is a perspective view illustrating the ratchet pulley system with the cable in an extended position according to an embodiment of the present invention of FIG. 1.

FIG. 5 is a flowchart illustrating a method of use for the ratchet pulley system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to ratcheting devices and more particularly to ratchet pulley system 100 as used to improve the speed and convenience of removing or installing fasteners.

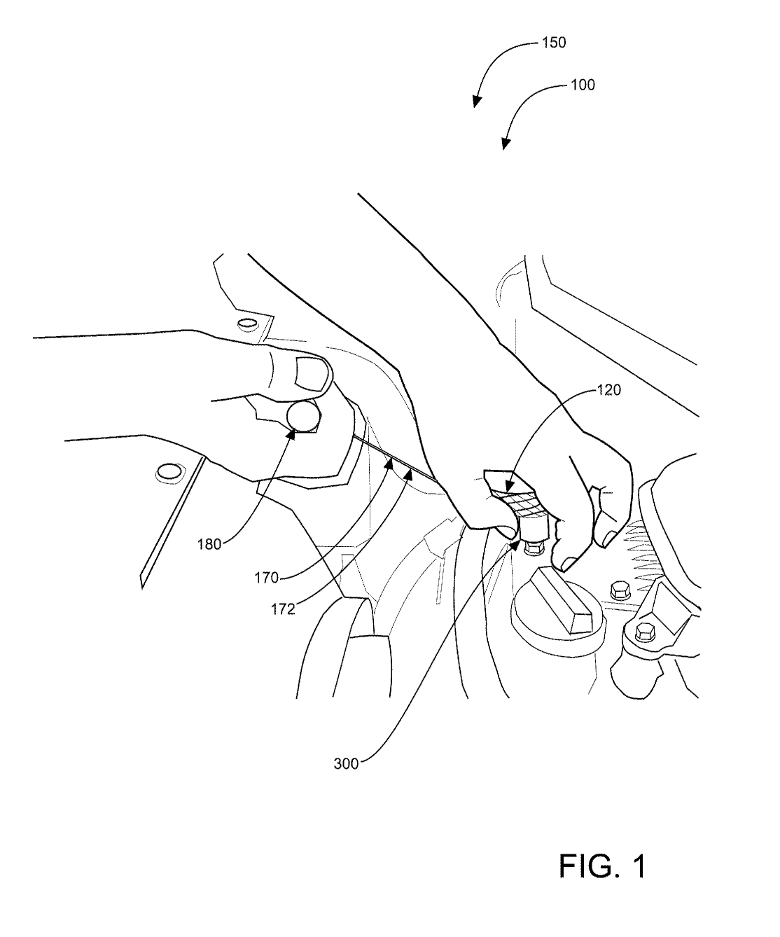

Referring to the drawings by numerals of reference there is shown in FIG. 1, torque multiplying ratchet pulley system 100 in an in-use condition 150. Torque multiplying ratchet pulley system 100 may be used to improve the efficiency of ratcheting and may be for use with conventional metric and SAE ½-inch or ⅜-inch drive socket(s) 300 or extension drives (other sizes may also be used.)

The present invention preferably comprises: extruded drive lug 110; grippable housing disk 120; at least one pulley 140 (shaft/bushing or other cable attachment means); pawl 160; and recoilable pull-cable 170 with handle 180. Extruded drive lug 110 is preferably in communication with or otherwise connected to recoilable pull-cable 170 such that when a user pulls recoilable pull-cable 170 via handle 180, extruded drive lug 110 and pulley 140 are rotated (pulley 140 rotated within grippable housing disk 120.) The head of the ‘driver’ is preferably a flat, disk-shaped pulley 140, equipped with recoilable pull-cable 170, as well as preferably a detachable version of solid handle 180. Since recoilable pull-cable 170 may be coiled about the axis of shaft 114, a relatively wide diameter pulley 140 the rotation provides far greater torque (at least herein enabling torque multiplying means) on extruded drive lug 110 and socket(s) 300, and therefore on the fastener (in series.)

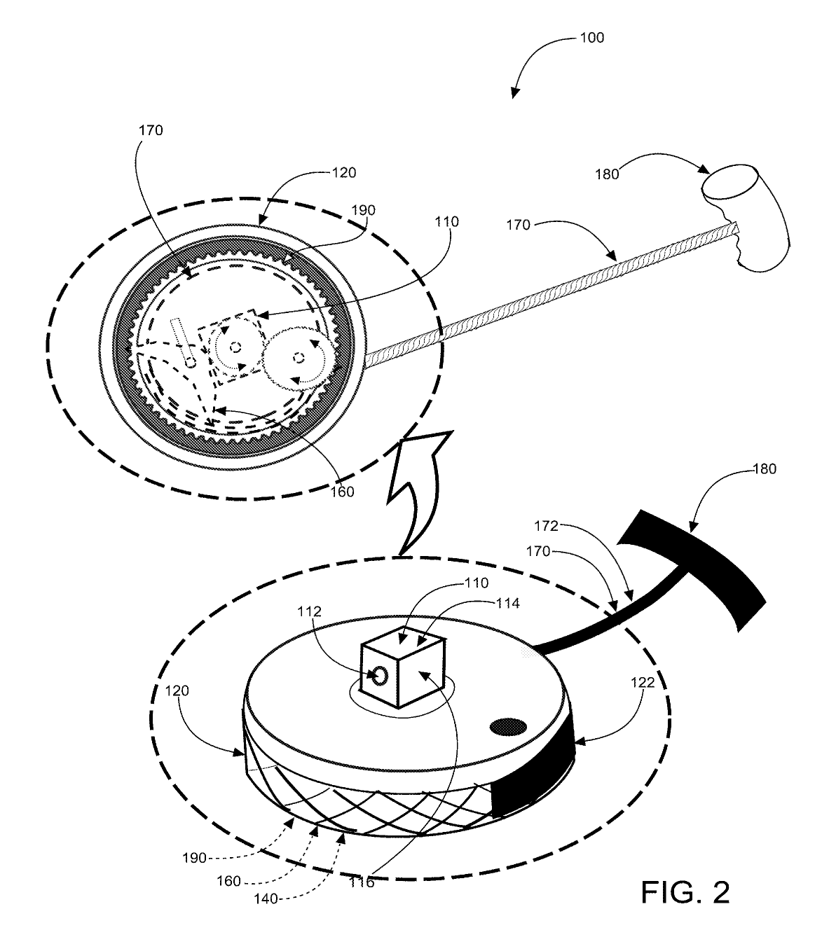

Referring now to FIG. 2, showing a perspective view illustrating torque multiplying ratchet pulley system 100 in a perspective view according to an embodiment of the present invention of FIG. 1. Extruded drive lug 110 may be mounted on bearings within grippable housing disk 120, and is thereby rotatable with recoilable pull-cable 170. Recoilable pull-cable 170 is substantially enclosed within grippable housing disk 120 in a non-use condition, wherein recoilable pull-cable 170 is affixed to shaft 114 and wound circumferentially around pulley 140. Pulley 140 has ratchet teeth 190, in preferred embodiments, circumferentially located thereon, into which pawl 160 may engage to create an incremental stop and go movement. Additionally, pawl 160 and ratchet teeth 190 in combination may comprise pawl position lock 164. Recoilable pull-cable 170 preferably comprises braided steel cable 172 and is pulled tangentially from pulley 140 by the user via the (T-shaped pull) handle 180 to create at least one torque moment at extruded drive lug 110 to impart on socket(s) 300. In versions using recoilable pull-cable 170 springs or other recoiling enabling means may be employed.

Pawl 160 of torque multiplying ratchet pulley system 100 is described above preferably comprises engaging/disengaging lever 162 to allow a user to repeatably manipulate the present invention between engaged and disengaged positions/conditions (locked/unlocked or other.) In this way, extruded drive lug 110 is rotationally reversible when engaging/disengaging lever 162 having disengaged pawl 160. Extruded drive lug 110 also preferably comprises detent 112 for contact-coupling to socket(s) 300. Further, torque multiplying ratchet pulley system 100 preferably comprises through shaft 114 within grippable housing disk 120 which may extend centrally through and may be affixed to pulley 140 such that it is rotatable in relation to grippable housing disk 120.

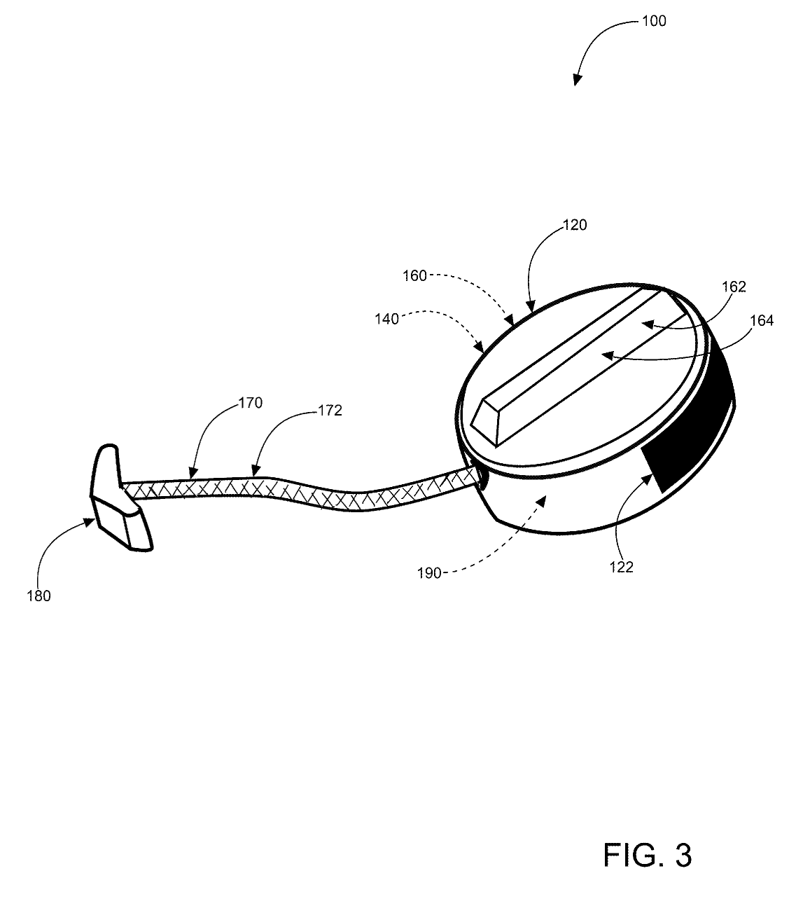

Referring now to FIG. 3 showing another perspective view (top-view) illustrating torque multiplying ratchet pulley system 100 according to an embodiment of the present invention of FIG. 1. Braided steel handle 180 may be suitably affixed to shaft 114, wound around pulley 140, and terminates in T-shaped handle 180. Torque multiplying ratchet pulley system 100 handle 180 is manipulatable via (optional) rigid arm 174 which is removably couplable in alternate embodiments in a similar way to engaging a ratchet arm to a socket 300, however with the advent that the user is able to additionally grip grippable housing disk 120. Grippable housing disk 120 is preferably circumferentially bonded with rubber grip 122 (or other suitable friction-enhancing/gripping means.) Torque multiplying ratchet pulley system 100 is able to accommodate detachable rigid arm which ‘engagably-locks’ to grippable housing disk 120 allowing a user to apply a torque moment when pawl position lock 164 provides for such movement. Extruded drive lug 110 may comprise ½″ drive or a ⅜″ drive 116 cubed profile and is coupleable with standard SAE or metric socket(s) 300.

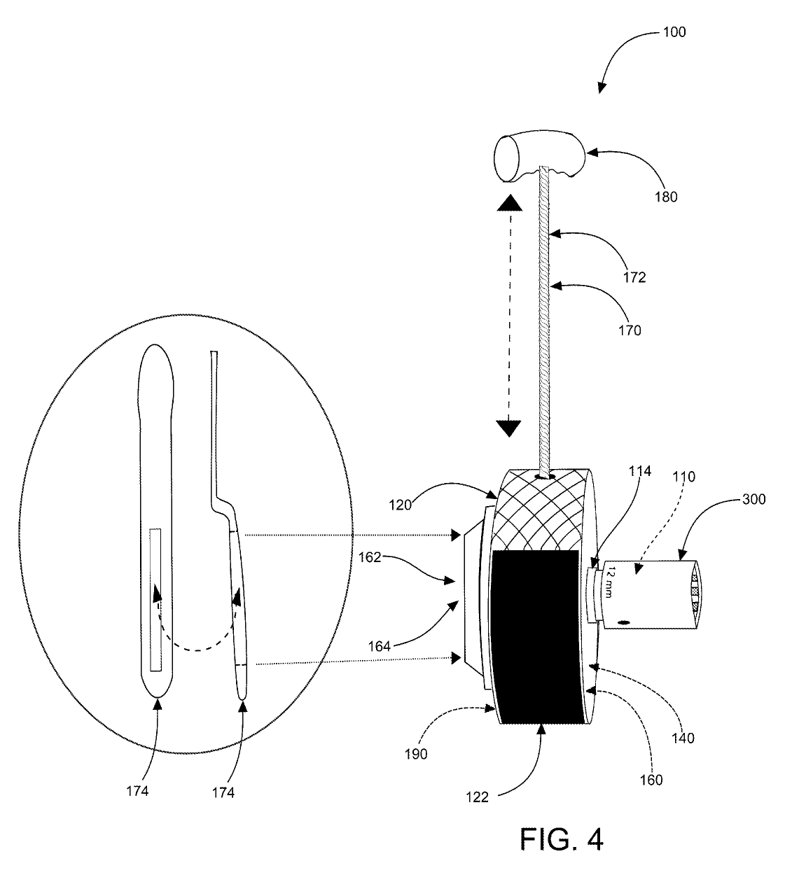

Referring now to FIG. 4, showing Torque multiplying ratchet pulley system 100. Torque multiplying ratchet pulley system 100 may be sold as kit 350 comprising the following parts: at least one grippable housing disk 120 (with components described herewithin); an optional removable rigid handle 180; socket(s) 300; and at least one set of user instructions. Torque multiplying ratchet pulley system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

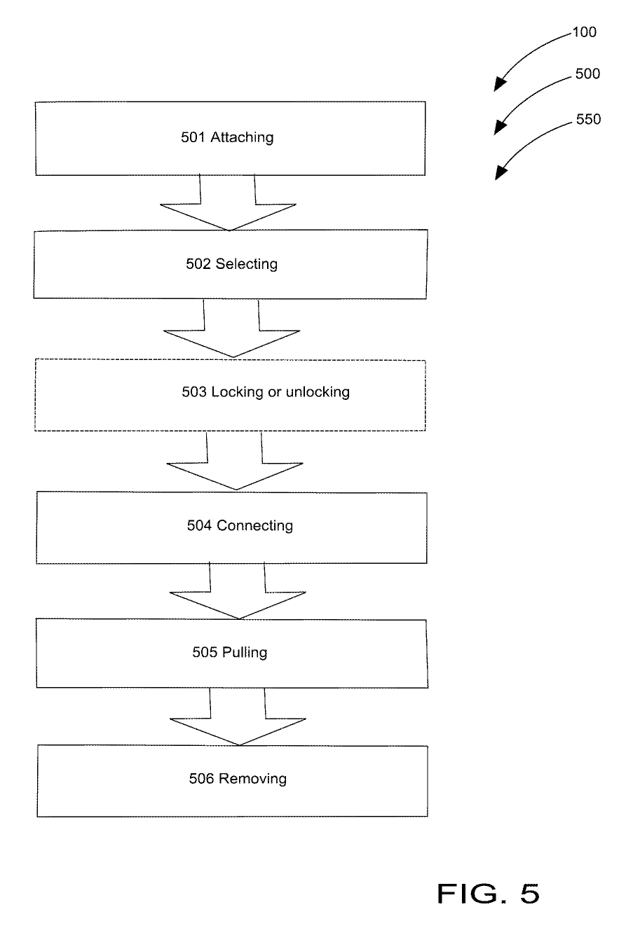

Referring now to FIG. 5, a method of use 500 for torque multiplying ratchet pulley system 100 may comprise the steps of: step one 501 attaching standard SAE or metric socket(s) 300 onto extruded drive lug 110; step two 502 selecting a direction of rotation with engaging/disengaging lever 162; step three 503 connecting socket(s) 300 on torque multiplying ratchet pulley system 100 to a fastener; step four 504 pulling recoilable pull-cable 170 via handle 180 to loosen or tighten the fastener; and step five 505 removing socket(s) 300 when the fastener is adequately tightened or loosened. The method may further comprises step six 506 locking or unlocking pawl position lock 164 to retain a suitable fastener positioning (and readjusting.)

It should be noted that step 506 is an optional step and may not be implemented in all cases. The optional step of method 506 is illustrated using dotted lines in FIG. 5 so as to distinguish it from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A torque multiplying ratchet pulley comprising:
an extruded drive lug;
a grippable housing disk;
at least one pulley;
a pawl; and
a recoilable pull-cable with a handle;
wherein said extruded drive lug is connected to said recoilable pull-cable such that when a user pulls said recoilable pull-cable via said handle said extruded drive lug is rotated;
wherein said pulley is rotatable with said extruded drive lug and said pulley is enclosed within said grippable housing disk;
wherein said recoilable pull-cable is wound circumferentially around said pulley;
wherein said pulley has ratchet teeth circumferentially located into which said pawl engages to allow an incremental stop and go movement; and
wherein said recoilable pull-cable is pulled tangentially from said pulley via said handle to create at least one torque moment to a fastener.

2. The torque multiplying ratchet pulley of claim 1 wherein said pawl comprises engaging/disengaging lever.

3. The torque multiplying ratchet pulley of claim 3 wherein said extruded drive lug is rotationally reversible when said engaging/disengaging lever has disengaged said pawl.

4. The torque multiplying ratchet pulley of claim 1 wherein said extruded drive lug comprises a detent.

5. The torque multiplying ratchet pulley of claim 1 wherein said extruded drive lug comprises a through shaft within said grippable housing disk.

6. The torque multiplying ratchet pulley of claim 5 wherein said through shaft extends centrally through and is affixed to said pulley such that it is rotatable in relation to said grippable housing disk.

7. The torque multiplying ratchet pulley of claim 6 wherein said recoilable pull-cable is affixed to said shaft and wound around said pulley.

8. The torque multiplying ratchet pulley of claim 7 wherein said recoilable pull-cable comprises braided steel cable.

9. The torque multiplying ratchet pulley of claim 6 wherein said recoilable pull-cable terminates with said handle, said handle comprising a T-shape.

10. The torque multiplying ratchet pulley of claim 3 wherein said recoilable pull-cable is manipulatable via a rigid arm.

11. The torque multiplying ratchet pulley of claim 1 wherein said grippable housing disk is circumferentially affixed to a rubber grip.

12. The torque multiplying ratchet pulley of claim 1 wherein said grippable housing disk comprises a pawl position lock.

13. The torque multiplying ratchet pulley of claim 10 wherein said rigid arm is removably couplable.

14. The torque multiplying ratchet pulley of claim 13 wherein said rigid arm locks to said grippable housing disk allowing said user to apply said torque moment when said pawl position lock is in a locked condition thereby creating a direct drive.

15. The torque multiplying ratchet pulley of claim 1 wherein said extruded drive lug comprises a ½ inch drive or a ⅜ inch drive.

16. The torque multiplying ratchet pulley of claim 14 wherein said extruded drive lug comprises a cubic profile insertable into a socket.

17. A torque multiplying ratchet pulley comprising:
an extruded drive lug;
a grippable housing disk;
at least one pulley;
a pawl; and
a pull-cable with a handle;
wherein said extruded drive lug is connected to said pull-cable such that when a user pulls said pull-cable via said handle said extruded drive lug is rotated;
wherein said pulley is rotatable with said extruded drive lug and said pulley is enclosed within said grippable housing disk;
wherein said pull-cable is wound circumferentially around said pulley;
wherein said pulley has ratchet teeth circumferentially located into which said pawl engages to create a incremental stop and go movement;
wherein said pull-cable is pulled tangentially from said pulley via said handle to create at least one torque moment;
wherein said pawl comprises engaging/disengaging lever;
wherein said extruded drive lug is rotationally reversible when said engaging/disengaging lever has disengaged said pawl;
wherein said extruded drive lug comprises a detent;
wherein said extruded drive lug comprises a through shaft within said grippable housing disk;
wherein said through shaft extends centrally through and is affixed to said pulley such that it is rotatable in relation to said grippable housing disk;
wherein said pull-cable is affixed to said shaft and wound around said pulley;
wherein said pull-cable comprises braided steel cable;
wherein said pull-cable terminates with said handle, said handle comprising a T-shape;
wherein said pull-cable is manipulatable via a rigid arm;
wherein said grippable housing disk comprises said rigid arm which is removably couplable;
wherein said rigid arm locks to said grippable housing disk allowing the user to apply said torque moment when said pawl position lock is in a locked condition thereby creating a direct drive;
wherein said grippable housing disk is circumferentially bonded with a rubber grip;
wherein said grippable housing disk comprises a pawl position lock;
wherein said extruded drive lug comprises a ½″ drive or a ⅜″ drive; and
wherein said extruded drive lug comprises a cube profile insertable into a socket suitably to drive a fastener.

18. The torque multiplying ratchet pulley system of claim 17 comprising a kit having said torque multiplying ratchet pulley; said removable rigid handle; said sockets; and a set of user instructions.

19. A method of use for a torque multiplying ratchet pulley comprising the steps of:
attaching a standard SAE or a Metric socket to an extruded drive lug;
selecting a direction of rotation with a rotation selector;
attaching said socket connected to said torque multiplying ratchet pulley to a fastener;
pulling said pull-cable via said handle to loosen or tighten said fastener; and
removing said socket when said fastener is adequately tightened or loosened.

20. The method of claim 19 further comprising the step of locking or unlocking a pawl position lock to retain a suitable fastener positioning.
